(19) United States
(12) Patent Application Publication
(10) Pub. No.: US 2026/0295465 A1
(43) Pub. Date: Oct. 1, 2026

(54) ADJUSTABLE SPACING COALESCING MEDIA PLATE FOR OIL/WATER SEPARATION

(71) Applicant: PARK ENVIRONMENTAL EQUIPMENT, LLC, Houston, TX (US)

(72) Inventors: Christopher Nolan EBERLY, Chappell Hill, TX (US); Andreas H. VU, Houston, TX (US); Kate T. VU, Houston, TX (US)

(21) Appl. No.: 19/089,538

(22) Filed: Mar. 25, 2025

(51) Int. Cl. B01D 17/04; B01D 17/02

(52) U.S. Cl. CPC B01D 17/045; B01D 17/0211

(57) ABSTRACT

A coalescing stack for use with a coalescing system has first and second coalescing plates, a first connection affixed to the first coalescing plate so as to face the second coalescing plate, a first connection affixed to the second coalescing plate so as to face the first coalescing plate, and a second connection affixed to the second coalescing plate so as to face the first coalescing plate. The first connection of the first coalescing plate is joinable to one of the first and second connections of the second coalescing plate so as to define a first distance between the coalescing plates. The first coalescing plate is rotatable with respect to the second coalescing plate such that the first connection is joinable to another of the first and second connections of the second coalescing plate so as to define a second distance between the coalescing plates.

### CROSS-REFERENCE TO RELATED APPLICATIONS

Not applicable.

### FIELD OF THE INVENTION

The present invention relates to coalescing systems for the separation of oil and water. More particularly, the present invention relates to a coalescing stack used in such a coalescing system. More particularly, the present invention relates to the adjustable spacing between the coalescing plates of the coalescing system.

### BACKGROUND OF THE INVENTION

There is a need for economical oil/water separators to process rainwater and industrial wastewater so as to remove hydrocarbons and vegetable oils. These oil/water separators can also remove incidentally included oil from machine-tool coolant. Coalescing media is often used as part of the oil/water separators. Coalescing media consists of stacked plates composed generally of plastic and other materials. The stacked plates may be flat, corrugated or angled in multiple corrugated plates or in a coalescing plate stack. Coalescing media can be stacked either horizontally or at an angle from horizontal. The coalescing media as part of the separator which actually capture small oil droplets in order to remove them from flowing downstream, and directs the captured oil to the upper surface of the water. Typically, the oil is captured on the underside of the plates according to Stokes' law by the oil droplets rising up to meet the underside of the plates and forming a film thereon and eventually migrating up to the underside of the plates to the oil ports in the peaks of the plates.

An example of a coalescing plate packing system of the prior art was shown in U.S. Pat. No. 5,068,035, issued on Nov. 26, 1991 to K. S. Mohr. This coalescing plate packing system is illustrated, in particular, in association with the prior art of FIGS. 1 and 2. FIGS. 1 and 2 show a system for separating immiscible heavier and lighter components of a fluid mixture. The system includes a vessel 10 having a bottom 12, and an open top 14. It also includes end walls 16 and 18 that are in parallel planar relationship to each other. There also parallel planar side walls 20 and 22 (see FIG. 2). The vessel 10 includes a mixture inlet 24, a lighter component outlet 26 and a heavier component outlet 28. A weir 30 provides a means of skimming off lighter components, such as oil.

The system 10 has the lighter oil component accumulated on the top of the mixture and flows over the top edge 30A of weir 30 into the lighter component outlet 26. In contrast, water 34 accumulates in the lower portion of the vessel. The interface between the lighter component, oil and the heavier component (water) is indicated at 36. A means is provided for maintaining interface 36 at a preselected level below the top edge 30A of weir 30. A float 38 senses the level of interface 36 and, by means of a control system, water 38 is drained from the vessel through a pneumatic line 44 through a control valve 46. This maintains the interface level 36.

In order to enhance the separation of lighter components from heavier components of a mixture, a coalescing pack 48 is provided. The coalescing pack is assembled as a unit outside of the vessel 10 and placed as a unit into the vessel. The coalescing pack 48 includes a plurality of coalescing plates 50, a pair of bottom supports 52 and 54 that stand upright in spaced parallel planes, and a pair of top supports 56 and 58 that are placed in vertical planes above the bottom supports 52 and 54, respectively.

Each of the coalescing plates 50 has orthogonally structured corrugations, running both laterally and longitudinally along a single plane of the plate. This arrangement provides the plates with crests and valleys. The openings 60 are provided in the valleys and presses. Semi-circular openings are provided in the edges. The semi-circular opening opens in the crest of the lateral corrugations when plates are joined contiguous to each other. The opening is formed in the lateral valleys of the corrugated plates 50 to permit the heavier liquid component (i.e. water) and particulate matter to migrate through the plates in vertical downward migration. The opening 60 in the crests permit the lighter component (i.e. oil) to migrate vertically upwardly.

FIG. 2 shows details, in an elevation view, of a bottom support 52 and a top support 56. The supports are preferably mold of a polymeric material. The supports 52 and 56 are used in an upright arrangement and spaced apart in generally parallel planes. The bottom support 52 has a bottom edge 64 that is preferably flat or at least of a configuration to substantially conform to the bottom 12 of the vessel 10.

Bottom support 52 further has an upper edge 66 that corresponds to the lateral core occasions of the coalescing plates 50. The perimeter of bottom support 50 is completed by opposite parallel sides 68 and 70. The spacing between the sides 68 and 70 is slightly less than the spacing between the vessel side walls 20 and 22. Bottom support 52 is preferably of a molded polymeric material and has integral reinforcing rib 72 that can be arranged in a variety of different configurations to add strength to the structure. The bottom support 52 is closed such that fluid cannot flow through it since there are no openings between the ribs.

The top support 56 is preferably molded of a polymeric material and has a top edge 74 that is generally flat. A bottom edge is undulating to conform to the lateral corrugation of coalescing plates 50. Top support 56 further has opposed sides 78 and 80 that are parallel to each other and spaced apart by a width that is slightly less than the width of the vessel side walls 20 and 22.

Bottom support 52 has a small diameter vertical passageway 82 therein that is centrally located between sides 68 and 70. The top support 56 has a vertical passageway 84 equally spaced between sides 78 and 80. The passageways 82 and 84 are in vertical alignment with each other. Openings 82 and 84 receive an elongated rod 86 that has a threaded portion adjacent each other. Rod 86 is used for each of the pair of top and bottom supports. Nuts 88 and 90 are used to secure the stack of coalescing plates 50 between the opposing pairs of bottom supports 52 and 54 and the top supports 56 and 58 in a unitary package. Thus, the coalescing package 48 can be assembled and installed into the vessel. Each of the top supports 56 and 58 can have an integral lifting eye 92 and 94.

The top supports 56 and 58 each has semi-circular recesses at the opposed sides 78 and 80. Recesses 96 coincide in alignment with the semi-circular opening 62 of the coalescing plates. The recess 96 in the top and bottom supports and the semi-circular opening 62 in the coalescing plates receive tubes 98. Tubes 98 may be inserted into the aligned semi-circular openings in the top and bottom coalescing supports after the pack 48 is inserted into the vessel 10.

The support legs of FIGS. 1 and 2 require plastic injection molding with two separate tools and a complex two-axis actuation. As such, the system of FIGS. 1 and 2 utilizes excess material. The use of this two-axis actuation in the manufacturing process increases production time and increases costs. This requirement during the manufacture of these top and bottom supports has adds complexity and requires unnecessary equipment.

In the past, a variety of patents and publications have issued with respect to such coalescing plate packs and the supports associated therewith. An early patent is that of U.S. Pat. No. 3,847,813, issued on Nov. 12, 1974 to J. L. Castelli. This patent describes a coalescing plate for a fluid mixture plate separator. These coalescing plates are formed with integral spacers so as to permit the plates to be joined in the stacks. The stacks can be made with the plates vertically aligned or offset laterally for inclined stacks.

U.S. Pat. No. 4,802,978, issued on Feb. 7, 1989 to Schmit et al., teaches an oil/water separator that having a vertical, cylindrical tank with a plurality of corrugated, oleophilic plates. A corrugated diffusion baffle is located adjacent an oil/water mixture inlet to remove the larger particulate material from the mixture and cause coalescing of the larger oil droplets. The flow of the oil/water mixture proceeds generally in a vertical direction and passes between the corrugated plates to cause further coalescing of the oil droplets. A separate oil channel directs the coalesced oil to an upper portion of the tank. The clarified water then passes downwardly to a clean water outlet.

U.S. Pat. No. 5,762,810, issued on Jun. 9, 1988 to Pelton et al. discloses a coalescing oil/water separator for removing free and dispersed oil from a wastewater stream with increased separation efficiency so as to produce a substantially oil-free effluent. The coalescing oil/water separator is self-contained in a tank shell and includes an improved oil coalescing medium for separating oil out of the wastewater and a series of baffles and weirs to direct flow, to skim the separated oil, and to control the liquid level in the separator. The oil coalescing medium includes a plurality of molded, stackable perforated sheets or plates having an oleophilic surface and an increased coalescing surface area for inducing impingement of oil droplets on the medium surface. Each stackable sheet includes a plurality of openings and recesses which are aligned and positioned to form numerous closely-spaced vertical and horizontal communicating passages for maximizing the flow rate of wastewater while simultaneously maximizing the coalescing surface area of the medium.

U.S. Pat. No. 6,730,236, issued on May 4, 2004 to G. E. Kouba, provides a method of separating liquids in a separation system having a flow coalescing apparatus. The flow conditioning apparatus includes an inlet, an outlet, and a swirl chamber extending along a swirl axis. The inlet and outlet cooperate with the swirl chamber to create a swirling of a fluid mixture passing through the swirl chamber to ideally induce coalescence of liquid droplets. The flow of the fluid mixture through the apparatus encounters a minimum of fluid shear and associated droplet dispersion.

U.S. Pat. No. 7,416,657, issued on Aug. 26, 2008 to R. J. Kretchmar, describes an oil/water coalescing separator that is a coalescing chamber containing an oil-coalescing media. The separator is substantially transparent so that the thickness of the band of coalesced oil can be visually discerned at a glance. The separator has a magnet base so the separator can be hung on a machine and off the floor. The separator is also removable from the magnet base.

U.S. Pat. No. 8,985,343, issued on Mar. 24, 2005 to K. S. Mohr, teaches a separator plate used for separating immiscible liquids and solids from a liquid mixture. The oil/water separator plate is composed of bi-directional corrugations extending in both lateral and longitudinal directions, thereby forming a plurality of peaks and valleys. A ramp extends from each peak to the neighboring valleys. An elongated oil port is formed in the peak for passing immiscible liquids that disengage from the liquid mixture. Fences are included along the lower surface of the plate to guide the rising immiscible liquid. The separator plate is configured for stacking by selectively engaging a pin with one of a number of sockets in another plate. The pin and sockets permit varied vertical spacing and alignment in both lateral directions and longitudinal directions.

U.S. Pat. No. 9,289,700, issued Mar. 22, 2016 to Andreussi, provides a coalescence separator for a mixture of immiscible phases with different specific densities. The apparatus includes a tubular body close to the opposite ends and an inlet mouth. There is an outlet mouth of a fluid phase which is defined close to the end of the tubular body at an upper location. Another outlet mouth of the fluid phase is defined close to the end of the tubular body at a lower height. A set of coalescence plates are housed inside the tubular body. Each of the coalescence plates has a flow plate which is tilted at an angle with respect to a plane orthogonal to the longitudinal axis of the tubular body and which has a lower edge facing an end of the tubular body at a lower height and in fluid communication with a distribution channel of the mixture to be separated.

U.S. Pat. No. 11,691,093, issued on Jul. 4, 2023 to Oshinowo et al., provides a coalescing plate having a phyllotaxis-derived pattern. This coalescer plate separates a mixture of immiscible fluids. The coalescer plate includes a pattern of wetting and non-wetting ring regions.

Canadian Patent No. 2 389 065, issued on Jan. 24, 2003 to G. G. Aymong, provides a coalescer apparatus in an oil/water separator. The coalescer includes a frame that supports coalescing plates that are inclined upwardly from the bottom of the frame member. The coalescing plates run parallel to each other that are spaced equally apart. The coalescing plates have a bottom surface that is corrugated and a top surface that is flat without corrugations. Water containing oil and solids is passed through the coalescing apparatus and separation of the oil and solids from the water occurs. The solids fall to the top flat surface of the inclined coalescing plates. The inclined flat surface causes the solids to slide down the plate and out of the coalescer.

Canadian U.S. Pat. No. 1,149,756, issued on Jul. 12, 1983 to P. B. Smith, also discloses a coalescer plate for oily water separation. The separator has a plurality of parallel corrugated plates between which the oil/water mixture is constrained to flow. The adjacent plates are separated by spacing and are smoothly shaped to provide substantially laminar flow therealong in a direction generally transverse to the corrugations. A spacing is positioned between a pair of plates at a crest or at a trough in the corrugations.

Korean U.S. Pat. No. 100,230,914, issued on Nov. 15, 1999, teaches a separator for water and oil having a dam plate having a plurality of through holes for passing water and oil therethrough. Front and rear flow rate distribution plates have slits elongated in the longitudinal direction at predetermined intervals to distribute the flow rate of the mixed water passing through the through hole of the dam plate. A continuous air ridge and a valet, along with an air chamber, is formed in each ridge so as to define a plurality of water layers. An oil/water separation layer causes the oil floating in the water layers of the air chambers to float to the uppermost surface of the collection tank.

Traditional coalescing plates are limited by fixed spacing configurations. This fixed spacing configuration restricts the ability of such coalescing plates to adapt to varying flow rates, contamination loads and operational environments. Any attempt in the prior art so as to vary the spacing between the coalescing plates requires additional components and complex installation. As such, a need has developed so as to provide variable vertical spacing between the coalescing plates.

It is an object to the present invention to provide coalescing media plates that have adaptable spacing through rotation.

It is another object of the present invention to provide coalescing media plates that optimize oil/water separation performance.

It is another object of the present invention to provide coalescing media plates that are flexible and adaptable to the oil/water being treated.

It is another object of the present invention to provide coalescing media plates that enhance customizability.

It is still another object of the present invention to provide coalescing media plates that have improved versatility.

It is another object of the present invention to provide coalescing media plates that reduces the need for additional tools or parts.

It is another object of the present invention to provide coalescing media plates that have reduced installation time.

It is another object of the present invention to provide coalescing media plates that have reduced inventory requirements.

It is another object of the present invention to provide coalescing media plates that eliminate the need for multiple fixed spacing plate designs.

It is still another object of the present invention to provide coalescing media plates that mitigate fouling or clogging.

It is another object of the present invention to provide coalescing media plates that provide for easier cleaning.

It is another object of the present invention to provide coalescing media plates that have stable and secure stacking.

It is another object of the present invention to provide coalescing media plates that have enhanced droplet coalescence and separation.

It is still a further object to the present invention to provide coalescing media plates that maximize coalescence efficiency.

It is another object of the present invention to provide coalescing media plates that are cost-effective.

It is still a further object of the present invention to provide coalescing media plates that provide for consistent laminar flow.

It is still further object of the present invention to provide coalescing media plates that are retrofitable into existing oil/water separation systems.

These and other objects and advantages of the present invention will become apparent from a reading of the attached specification and appended claims.

### SUMMARY OF THE INVENTION

The present invention is a coalescing system for separating immissible compounds of different densities mixed in a fluid. This coalescing system includes a vessel having a fluid inlet and a lighter component outlet and a heavier component outlet, and a coalescing stack positioned in the vessel. The coalescing stack has a plurality of stack and, in particular, a first coalescing plate and a second coalescing plate. The first coalescing plate has a first connection thereon. The second coalescing plate has a first connection and a second connection thereon. The first connection of the first coalescing plate is joinable to one of the first connection and the second connections of the second coalescing plate so as to define a first distance between the first coalescing plate and the second coalescing plate. The first coalescing plate is rotatable with respect to the second coalescing plate such that the first connection of the first coalescing plate is joinable to the other of the first connection and the second connection of the second coalescing plate so as to define a second distance between the first coalescing plate and the second coalescing plate.

It should be noted that, in the present invention, each of the coalescing plates is generally of a rectangular construction and is identical in connections and the positions of such connections on the coalescing plate. As such, the second coalescing plate needs to be rotated in order to connect it to the below first coalescing plate. The position of the sleeves and the tiered supports are uniquely placed so that they never overlap for different distance settings.

Each distance is created uniquely by connecting two connection parts with each other. Each of the four distances associated with the variable spacing of the coalescing plates of the present invention is created by a set of five connections on each coalescing plate. Five connections are located on the first plate and five connections are located on the second plate so as to establish a first distance. Five connections are on both of the coalescing plates to establish a second distance. Similarly, this is created for both of the third and fourth distances. As such, there are a total of twenty connectors on each of the coalescing plates. When in the form of a rectangular plate, only two distances are achievable. As such, there are a total of forty connectors on the entire plate. Only ten connectors are used for each distance of one-quarter inch and one-half inch.

In general, the first connection in distance is one quarter inch. This involves a pilot sleeve and a tiered support for with a first shoulder. The second connection distance is one-half inch. This involves an open top of the tiered support plus a lower end of the tiered support. The third connection distance is three-quarters inch. This utilizes a smaller pilot sleeve with a second shoulder of the tiered support. Finally, the fourth connection has a distance of one inch. This involves the index support plus a lower end of the tiered support index. It is important to note that each connection has truly unique dimensions. As such, no connection part of either of the first and second coalescing plates can be “reused” for connection at a different or unintended distance.

The coalescing stack has a first coalescing plate, second coalescing plate and other coalescing plates thereafter. The second coalescing plate is rotatable with respect to the first coalescing plate such that the first connection of the first coalescing plate is joinable to the first connection of the second coalescing plate so as to define a first distance between the first coalescing plate and the second coalescing plate. The second coalescing plate is rotatable with respect to the first coalescing plate such that the second connection of the first coalescing plate is joinable to the second connection of the second coalescing so as to set a second distance between the first coalescing plate and the second coalescing plate. The second coalescing plate is rotatable with respect to the first coalescing plate such that a third connection of the first coalescing plate is attachable to a third connection of the second coalescing plate so as to define a third distance. The second coalescing plate is rotatable with respect to the first coalescing plate such that the fourth connection of the first coalescing plate is joinable to a fourth connection of the second coalescing plate so as to define the fourth distance.

The first and second coalescing plates each have a third connection. The second coalescing plate is rotatable with respect to the first coalescing plate such that the third connection of the first coalescing plate is joinable to the third connection of the second coalescing plate so as to define a third distance between the first coalescing plate and the second coalescing plate. The first and second coalescing plates also have the fourth connection. The second coalescing plate also has the fourth connection. The first coalescing plate is rotatable with respect to the second coalescing plate such as first connection of the first coalescing plate is joinable with the fourth connection of the second coalescing plate so as to define the fourth distance between the first coalescing plate and the second coalescing plate. Additionally, each of the first and second coalescing plates can have the fourth connection. The second coalescing plate can be rotatable with respect to the first coalescing plate such that the fourth connection of the first coalescing plate is enjoyable to the fourth connection of the second coalescing plate so as to define a fourth distance between the first coalescing plate and the second coalescing plate.

Specifically, in an embodiment of the present invention, the first connection can be a pilot sleeve affixed to the first coalescing plate. The first connection of the second coalescing plate is a tiered support affixable to the second coalescing plate. The tiered support is a generally tubular member having a first shoulder formed thereon. The pilot sleeve bears against the first shoulder of the tiered support so as to define the first distance between the first coalescing plate and the second coalescing plate.

In another embodiment, the second connection can be a first tiered support affixed to the first coalescing plate. The second connection is a second tiered support affixed to the second coalescing plate. The first tiered support has an open end. The open end of the first tiered support receives a lower end of the second tiered support therein so as define the second distance between the first coalescing plate and the second coalescing plate.

In a further embodiment of the present invention, the third connection is a pilot sleeve affixed to the first coalescing plate. The third connection is a tiered support affixed to the second coalescing plate. The tiered support has a second shoulder formed thereon and is in spaced relation to the first shoulder of the tiered support. The pilot sleeve extends over the tiered support so as to bear against the second shoulder of the tiered support so as to define a third distance between the first coalescing plate and the second coalescing plate.

In a further embodiment of the present invention, the fourth connection can be an index support affixed to the first coalescing plate. The index support has a top directed toward the second coalescing plate. The fourth connection of the second coalescing plate is a tiered support. The tiered support has a receptacle and an end thereof. The top of the index support is receivable in the receptacle of the tiered support so as to define the fourth distance between the first coalescing plate and the second coalescing plate.

It should be noted that, from the above description, that the second coalescing plate can include the first connection, the second connection, the third connection, and the fourth connection thereon. The first coalescing plate can include multiple connections thereon. The connections of the first coalescing plate are matable with the connections of the second tiered support so as to establish the first distance, the second distance, the third distance, and the fourth distance between the first coalescing plate and the second coalescing plate. The simple rotation of the second coalescing plate with respect to the first coalescing plate and the joining of the particular connections on each of the plates can allow the user to set one of the four distances between the coalescing plates, as desired.

Specifically, with respect to the tiered support, the connection of the second coalescing plate can be such a tiered support. This tiered support is a tubular member having a first shoulder and a second shoulder thereon. The first shoulder is in spaced relation to the second shoulder longitudinally along the tiered support. The tiered support has a receptacle at one end thereof and an opening of an opposite end thereof. In the present invention, the connection of the first coalescing plate can be an index support having an end. The end of the index support is receivable in the receptacle of the tiered support. Still further, the connection of the second coalescing plate can be another tiered support having an end that is receivable in the opening of the tiered support of the first coalescing plate.

The present invention can also be a coalescing stack assembly for use in a coalescing system. The coalescing stack assembly has a first coalescing plate and a second coalescing plate extending and spaced relation. This coalescing stack assembly comprises a first coalescing plate, a second coalescing plate and other coalescing plates thereafter extending and spaced relation to each other. A first connection is affixed to the first coalescing plate so as to face the second coalescing plate. A first connection is also affixed to the second coalescing plate so as to face the first coalescing plate. A second connection is affixed to the first coalescing plate so as to face the second coalescing plate. A second connection is affixed to the second coalescing plate so as to face the first coalescing plate. The first connection of the first coalescing plate is joinable to the first connection of the second coalescing plate so as to define a first distance between the first coalescing plate and the second coalescing plate. The second coalescing plate is rotatable with respect to the first coalescing plate such that the second connection is joinable to the second connection of the second coalescing plate so as to define a second distance between the first coalescing plate and the second coalescing plate. Since the present invention can include a multiple of coalescing plates beyond the “first coalescing plate” and the “second coalescing plates”, similar relationships are established between the various subsequent coalescing plates of the coalescing stack.

A third connection is affixed to the second coalescing plate so as to face the first coalescing plate. The second coalescing plate is rotatable such that the third connection of the first coalescing plate is joinable to the third connection so as to define a third distance between the first coalescing plate and the second coalescing plate. A fourth connection is affixed to the second coalescing plate so as to face the first coalescing plate. The second coalescing plate is rotatable such that the first connection of the first coalescing plate is joinable to the fourth connection of the second coalescing plate so as to define a fourth distance between the first coalescing plate and the second coalescing plate. The first distance is one-quarter inch. The second distance is one-half inch. The third distance is three-quarters inch. The fourth distance is one inch.

In particular, the first connection of the first coalescing plate includes a pair of first connections and spaced relation to each other. The first connection of the second coalescing plate includes a pair of first connections in spaced relation to each other. The second connection of the second coalescing plate comprises a pair of second connections of the second coalescing plate. The second connection of the first coalescing plate includes a pair of first connections in spaced relation to each other. The second connection of the second coalescing plate comprises a pair of second connections in spaced relation to each other. An indicia is formed on the first coalescing plate and the second coalescing plate. This indicia is indicative of a direction of rotation of the second coalescing plate with respect to the first coalescing plate so as to move between the first distance and the second distance. A small indicia exists on every coalescing plate. This indicia of the top plate is used to rotated until it points to the needed height.

It should be noted that if the stack has four or more plates, one would use the indicia of the second plate to rotate to the particular benchmark of the first plate. The indicia of the third plate can then be used to rotate to another mark of the second plate. Ultimately, it can be used to rotate the topmost fourth plate with respect to the lower third plate to the mark on the third plate.

In the coalescing stack assembly of the present invention, the first connection of the first coalescing plate can be a sleeve. The sleeve extends around the first connection or the third connection of the second coalescing plate so as to set the first distance of the third distance between the coalescing plates. Alternatively, the first connection to the first coalescing plate can be a tiered support having a first shoulder and a second shoulder. Further, and alternatively, the second connection of the first coalescing plate can be a first tiered support having a first shoulder and a second shoulder. Still further and, alternatively, the fourth connection of the first coalescing plate can be an index support. The fourth connection on the second coalescing plate can be a tiered support with first and second shoulders. The tiered support receives a portion of the index support of the first coalescing plate therein so as to set the fourth distance between the first and the second coalescing plates. The present invention is a novel design for a coalescing media plate that introduces the unique feature of variable vertical spacing between the plates. This is achieved through an innovative rotational stacking mechanism. This offers a significant improvement in oil/water separation technology. This system provides users with unprecedented flexibility to optimize separation performance for diverse operational requirements.

Traditional coalescing plates were limited by fixed spacing configurations. This restricts their ability adapt to varying flow rates, contaminant loads, and operational environments. The present invention addresses these limitations with a simple, yet effective, design that enables four distinct vertical spacing options (i.e. 0.25 inches, 0.50 inches, 0.75 inches, and 1.0 inch) by rotating the plates during assembly. This eliminates the need for additional components, simplifies installation, and expands the versatility of the product across multiple industries and applications.

The present invention incorporates additional features that enhance its functionality. The present invention includes a secure interlocking mechanism and engineered surface geometries to maximize coalescence efficiency. This makes the present invention more cost-effective and versatile solution for industries that require reliable and customizable oil/water separation systems.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a side cross-sectional view of a prior art coalescing system.

FIG. 2 is an end cross-sectional view of the prior art coalescing system of FIG. 1.

FIG. 3 is an upper perspective view showing an array of coalescing plates used in the present invention in which each of the coalescing plates has a rectangular shape.

FIG. 4 shows the array of plates of FIG. 3 (after separation into square plates) rotated so as to establish different spacing between the respective plates.

FIG. 5 is a plan view of a single plate showing the connections thereon in the coalescing system of the present invention.

FIG. 6 is a lower perspective view showing the configuration of the coalescing plates of the present invention as bearing upon the tiered support.

FIG. 7 is a cross-sectional view of the tiered support of the present invention.

FIG. 8 is an upper perspective view showing the sleeves is mounted on the coalescing plate of the present invention.

FIG. 9 is a cross-sectional view of the sleeve as used on the coalescing plate of the present invention.

FIG. 10 is a side elevation of view showing the index support as used on the coalescing plate of the coalescing system of the present invention.

FIG. 11 is a plan view of a coalescing plate in accordance with the present invention showing, in particular, the breakaway seams.

FIG. 12 is a close-up detailed plan view of the coalescing plate of FIG. 11, showing the breakaway seam.

### DETAILED DESCRIPTION OF THE INVENTION

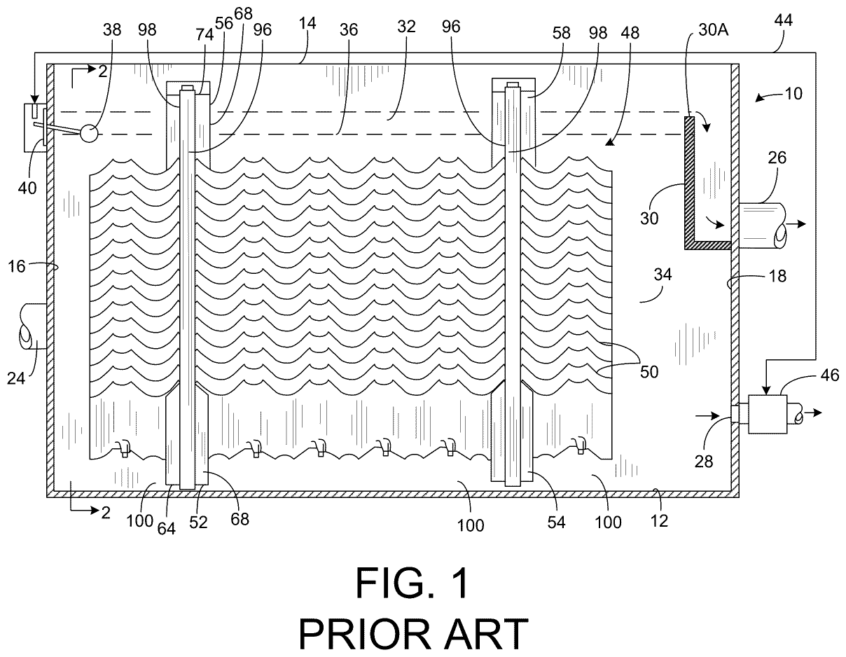

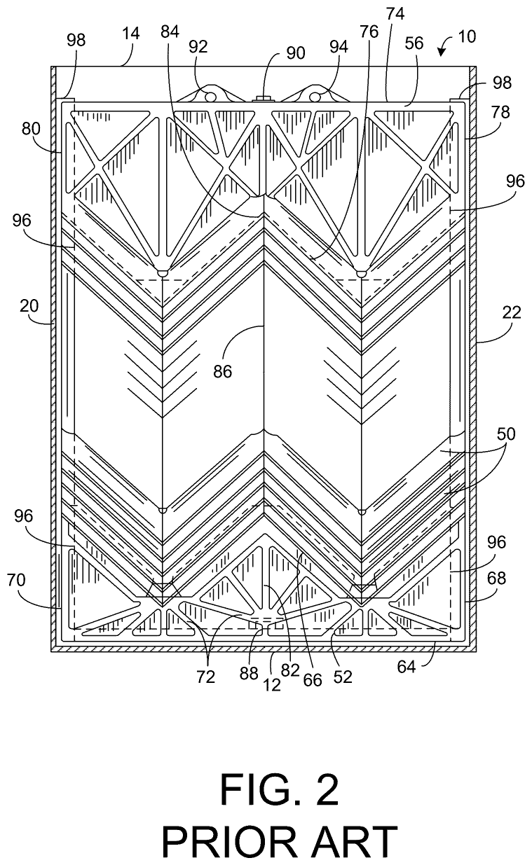

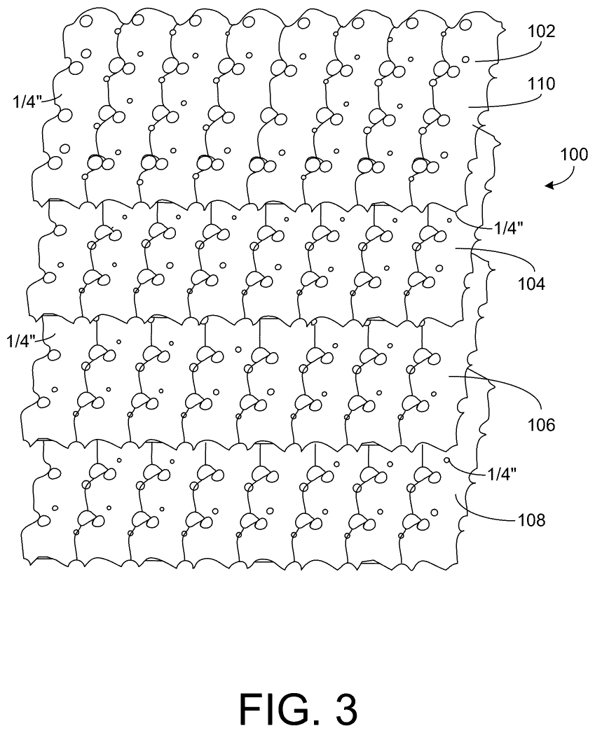

Referring to FIG. 3, there is shown the coalescing plate stack 100 in accordance with the teachings of the present invention. The coalescing plate stack 100 includes rectangular-shaped coalescing plates 102, 104, 106, and 108. As can be seen in FIG. 3, each of the rectangular-shaped coalescing plates 102, 104, 106 and 108 are spaced from each other in the coalescing stack 100. This particular spacing is indicated as being one-quarter inch. Indicia 110 is provided on the rectangular-shaped coalescing plates 102, 104, 106, 108 so as to indicate a direction of rotation of the coalescing plates so as to achieve a different spacing than the one-quarter inch shown in FIG. 3. Each of the rectangular coalescing plates 102, 104, 106, 108 will have configuration similar to that shown in the prior art illustrated in FIGS. 1 and 2.

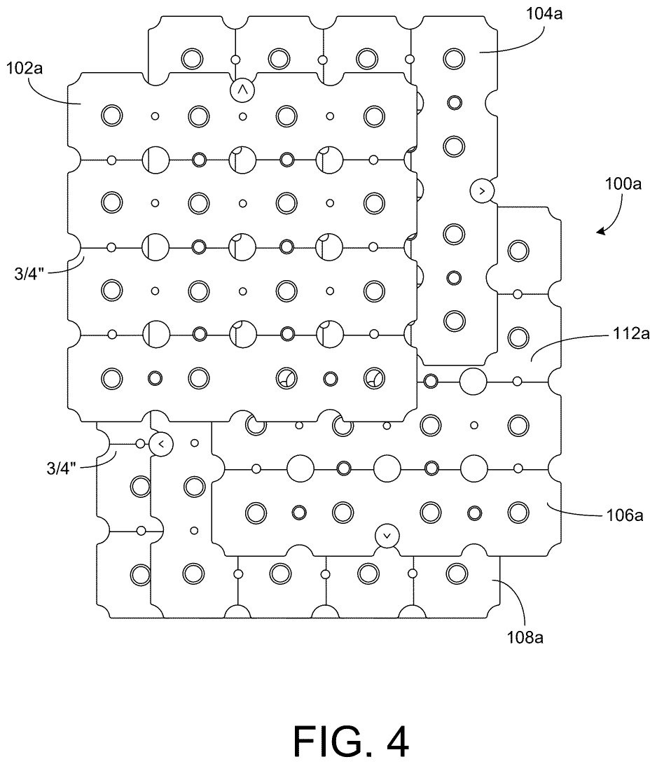

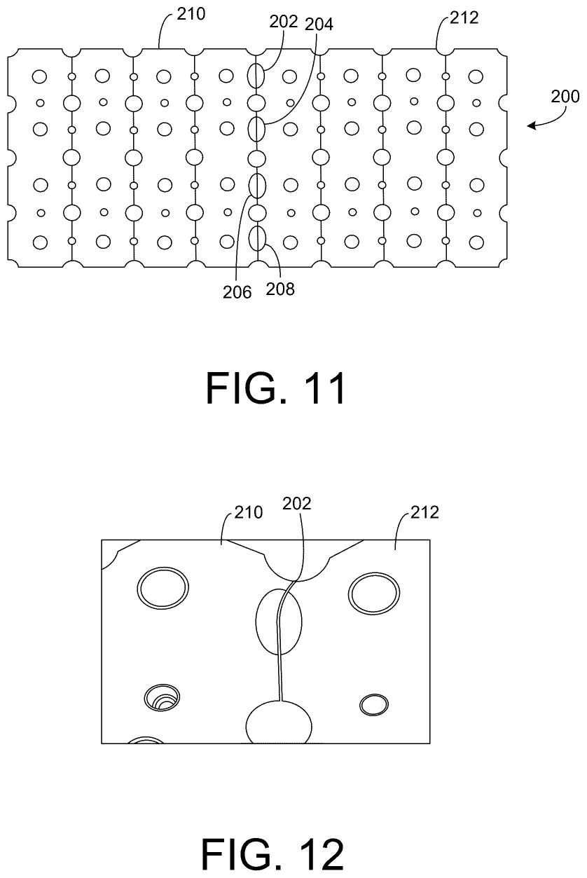

FIG. 4 shows the coalescing stack 100a with the square-shaped coalescing plates 102a, 104a, 106a and 108a. As can be seen, each of the coalescing plates 102a, 104a, 106a and 108a have been rotated with respect to each other so as to achieve a spacing distance of three-quarters inch between each of the respective plates. Indicia 112a is provided on the respective plates so as to indicate this distance or to indicate a direction of rotation. There is a breakaway seam provided on each of the coalescing plates 102a, 104a, 106a and 108a (as shown in FIG. 11). As such, each of the coalescing plates can be a reduced in area by one-half. The traditional 12″×24″ plate can be converted to a square 12″×12″ plate simply by breaking the breakaway seam on each of the rectangular plates.

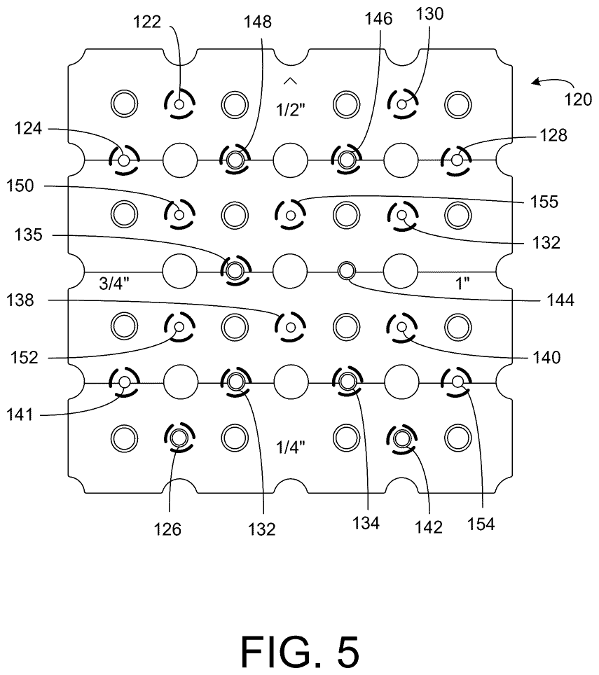

In order to achieve this variable spacing between the respective coalescing plates, FIG. 5 illustrates that various connections are formed on the coalescing plate 120. As used herein, the coalescing plate 120 can be the first coalescing plate and the second coalescing plate in the coalescing stack illustrated in FIGS. 3 and 4. The attachment of the various connections to the coalescing plate 102 are configured so as to face the other of the coalescing plates. In particular, FIG. 5 illustrates that the coalescing plate 120 includes a pilot sleeve 122, an index support 124, a tiered support 126 and another pilot sleeve 128. Each of these components will have the particular configuration shown in the following figures.

The pilot sleeve 122 will have a larger inner diameter than that of the pilot sleeve 128. The pilot sleeve 122 includes another pilot sleeve 130 in spaced relation along the surface of the coalescing plate 120. The pilot sleeve 122 includes several other pilot sleeves of the same dimensions located on the coalescing plate 120. In particular, there is shown pilot sleeves 130, 132, 134 and 135 affixed to the coalescing plate 120. As such, these pilot sleeves 122, 130, 132, 134 and 135 can be used so as to set up a one-quarter distance between the respective coalescing plates. These five pilot sleeves 122, 130, 132, 134 and 135 are arranged in spaced relationship across the surface of the coalescing plate 120. These contact points between the respective coalescing plates assures stability when the coalescing plates are in the spacing distance of one-quarter inch.

The index support 124 also includes several other index supports located on the coalescing plate 120. These include index support 136, index support 138 index support 140 and index support 141. When the coalescing plate 120 is joined to an adjacent coalescing plate, the use of the index supports 124, 136, 138, 140 and 141 will establish a one-inch stacking distance between the respective plates.

The tiered support 126 is affixed to the coalescing plate 120. There are several tiered supports that can be located on the coalescing plate 120. This includes tiered support 126, tiered support 142, tiered support 144, tiered support 146 and tiered support 148. As such, the proper rotation between the respective coalescing plates allows the tiered supports 126, 142, 144, 146, 148 to establish a one-half inch distance between the respective coalescing plates.

Additionally, and furthermore, there is another pilot sleeve 128 that has a lesser diameter than the pilot sleeve 122. Pilot sleeve 128 is adapted to extend around the tiered support of an adjacent coalescing plate. The coalescing plate 120 also includes additional smaller pilot sleeves 150, 152, 154, and 155. As such, these pilot sleeves can be used so as to establish a three-quarters inch separation distance between the respective coalescing plates.

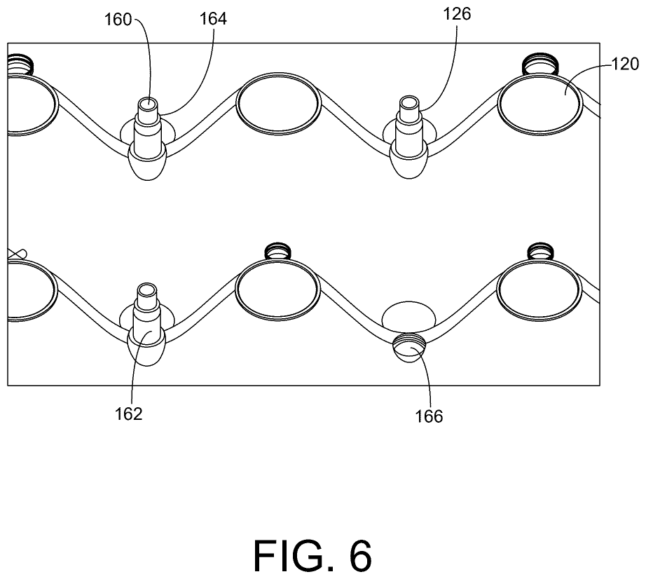

FIG. 6 shows a flipped detailed view of the installation of a tiered support 126 onto the coalescing plate 120a. As can be seen, the tiered support 126 is configured so as to extend downwardly from the surface of the coalescing plate 120. Tiered support 126 includes a receptacle 160 at one end thereof. The tiered support 126 is a generally tubular member that has a first shoulder 162 and a second shoulder 164 extending circumferentially around the outer diameter of each of the tiered supports. One tiered support can be positioned in a mounting hole 166 formed on the coalescing plate 120.

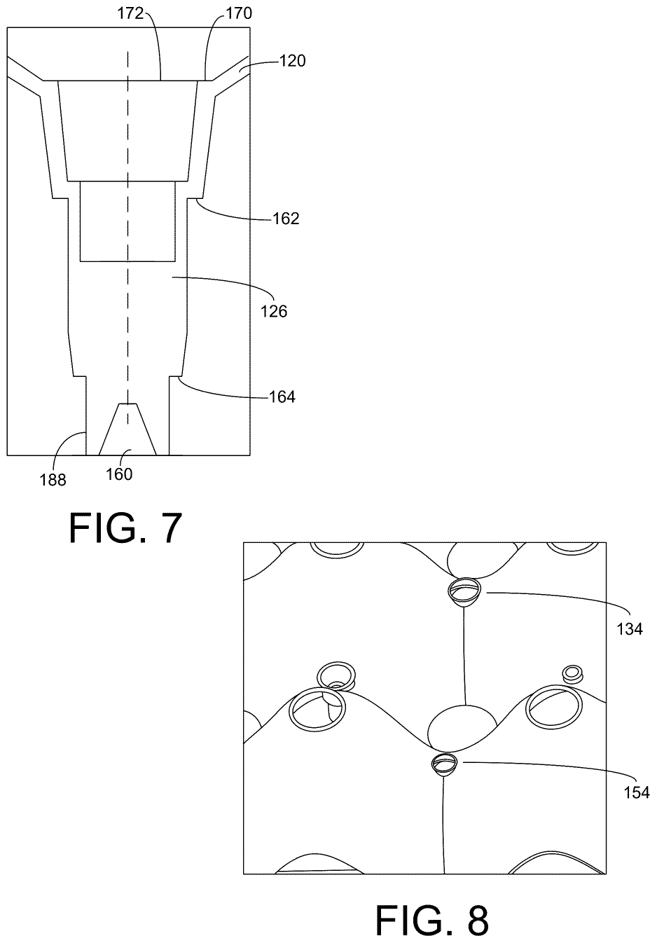

FIG. 7 particularly illustrates the configuration of the tiered support 126. FIG. 7 shows that the end 170 of the tiered support 126 is affixed to the mounting hole 166 of the coalescing plate 120. The end 160 has an opening 172 formed therein. Opening 172 will face one of the connectors event adjacent coalescing plate. The tiered support 126 also includes the receptacle 160 at the opposite end thereof. The first shoulder 162 and the second shoulder 100 and 164 are formed on the outer diameter of the tiered support 126.

FIG. 8 illustrates the configuration of the pilot sleeves 134 and 154 from the perspective of the lower right portion of FIG. 3 as zoomed from the right side. The hole 122 is in one of the plate peaks. When the pilot sleeves 134 and 154 are positioned on one of the coalescing plates, they can be suitably positioned so as to extend around the tiered support 126 in order to establish a proper spacing between the respective coalescing plates. As can be seen, the smaller diameter pilot sleeve 154 can reside upon the shoulder 164 of the tiered support 126. The pilot sleeve 134 (having a greater diameter than the pilot sleeve 154) can be positioned so as to reside upon the shoulder 162 of the tiered support 126. As such, the rotation of the respective coalescing plates with respect to each other can allow for variable spacing between the coalescing plates.

FIG. 8 illustrates the configuration of the pilot sleeves 122 and 128. As can be seen, the pilot sleeve 122 has a greater diameter than that of the pilot sleeve 128. When the pilot sleeves 122 and 128 are positioned on one of the coalescing plates, they can be suitably positioned so as to extend around the tiered support 126 in order to establish a proper spacing between the respective coalescing plates. As can be seen, the smaller diameter pilot sleeve 128 can reside upon the shoulder 164 of the tiered support 126. The pilot sleeve 128 (having a greater diameter than the pilot sleeve 128) can be positioned so as to reside upon the shoulder 162 of the tiered support 126. As such, the rotation of the respective coalescing plates with respect to each other can allow for variable spacing between the coalescing plates.

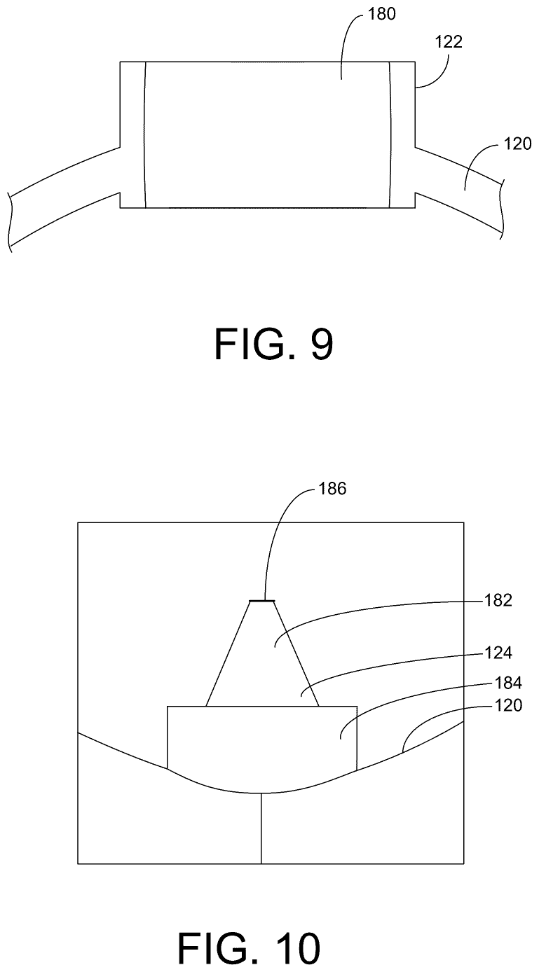

FIG. 9 shows, in particular, the cross-section of the pilot sleeve 122. It can be seen that the pilot sleeve 122 is affixed to the coalescing plate 120. The pilot sleeve 122 has an interior passageway 180 that is adapted so as to extend over the outer diameter of the tiered support 126 of an adjacent coalescing plate.

FIG. 10 shows the index support 124. Index support 124 is also affixed to the coalescing plate 120. Index support 124 includes a frustoconical member 182 that extends upwardly from a base 184. Ultimately, there is a pointed end 186 opposite the base 184. This pointed end 186 is adapted so as to be received within the receptacle 160 of the tiered support 126.

With reference to these figures, in order to achieve a spacing of one-quarter inch between the respective coalescing plates, the larger diameter pilot sleeve 134 will ultimately reside upon the first shoulder 162 of the tiered support 126. In order to achieve a spacing of one-half inch, the open end 172 of the tiered support 126 will receive the portion 188 at the opposite end of a tiered support of an adjacent coalescing plate. In order to achieve a spacing of three-quarters inch, the smaller diameter pilot sleeve 154 will reside upon the second shoulder 164 of the tiered support 126. In order to achieve a one-inch distance between the respective coalescing plates, the end 186 of the index support 124 will engage with the receptacle 160 of the tiered support 126 of an adjacent coalescing plate. As such, the rotation of the respective plates is carried out so as to align these various components with respect to each other in order to achieve the desired spacing between the plates.

In the simplest form of the present invention, the coalescing stack can be stacked in two ways. One creates a spacing between the stacked plates of one-quarter inch and the other creates a spacing of one-half inch. If desired, the rectangular plate can be separated at the frangible line into two approximately square plates. Each plate has the stacking mechanisms thereon in the manner shown in FIG. 5 so as to allow for variable distance between the stacking plates. The orientations of these various components on the coalescing plates never overlap with each other during the rotation of one plate with respect to the other plate. The use of these various components (as shown in FIG. 5) allow the coalescing plate assembly to establish different spacings of one-quarter inch, one-half inch, three-quarters inch, and one inch between the respective plates. Each of the plates can be rotated 90° with respect to each other so as to achieve these difference spacings. Once the 90° rotation is achieved, the coalescing plates can be joined together by affixing one of the above-stated components within the other component.

FIGS. 11 and 12 illustrate the coalescing plate 200 in accordance with an alternative embodiment of the present invention. The coalescing plate 200 is reflective of the coalescing plate 120 (as shown in FIG. 5 hereinabove). In particular, it can be seen the coalescing plate 200 has a generally rectangular configuration. Importantly, the coalescing plate 200 includes breakaway seams indicated by circular areas 202, 204, 206 and 208. These breakaway seams 202, 204, 206 and 208 can allow a first coalescing plate 210 to be separated from a second coalescing plate 212. Each of the first coalescing plate 210 and the second coalescing plate 212 will have a generally rectangular configuration, after being separated. Each of these coalescing plates 210 and 212 will have a configuration resembling that of the coalescing plate shown hereinabove in FIG. 5.

FIG. 12 illustrates a detailed view illustrating the breakaway seam 202 associated with the coalescing plates 210 and 212. A simple bending of the coalescing plates 210 and 212 with respect to each other to cause the coalescing plates to separate from each other. As such, the rectangular-shaped coalescing plate 200 can be utilized in its rectangular configurations in certain circumstances, or, if necessary, reduced in size to the square-shaped coalescing plates 210 and 212.

When the rectangular-shaped coalescing plate 200 is employed in the configuration of the present invention, the rectangular plate will have two stacking heights. The broken-away square plate has four stacking heights (in the manner described hereinabove).

The present invention provides variable vertical spacing between the coalescing plates. This is achieved through the innovative rotational stacking mechanism. As such, it is a significant advancement in oil/water separation technology. This adjustable spacing coalescing media plate provides users with unprecedented flexibility to optimize separation performance for diverse operational requirements. The ability to change the spacing between the plates provides the system with the ability to adapt to varying flow rates, contaminant loads and operational environments. It also eliminates the need for additional components. The installation is relatively simple. It also expands the versatility of the product across multiple industries and applications.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. A coalescing system for separating immiscible components of different densities mixed in a fluid, the coalescing system comprising:
a vessel having a fluid inlet and a lighter component outlet and a heavier component outlet; and
a coalescing stack positioned in said vessel, said coalescing stack having a first coalescing plate and a second coalescing plate, the first coalescing plate having a first connection, the second coalescing plate having a first connection and a second connection, wherein the first connection of the first coalescing plate is joinable to one of the first connection and the second connection of the second coalescing plate so as to define a first distance between the first coalescing plate and the second coalescing plate, the first coalescing plate being rotatable with respect to the second coalescing plate such that the first connection of the first coalescing plate is joinable to the other of the first connection and the second connection of the second coalescing plate so as to define a second distance between the first coalescing plate and the second coalescing plate.

2. The coalescing system of claim 1, wherein the second coalescing plate has third connection, the first coalescing plate being rotatable with respect to the second coalescing plate such that the first connection is joinable to the third connection upon a further rotation of the first coalescing plate with respect to the second coalescing plate so as to define third distance between the first coalescing plate and the second coalescing plate.

3. The coalescing system of claim 2, wherein the second coalescing plate has fourth connection, the first coalescing plate being rotatable with respect to the second coalescing plate such that the first connection of the first coalescing plate is joinable to the fourth connection of the second coalescing plate so as to define fourth distance between the first coalescing plate and the second coalescing plate.

4. The coalescing system of claim 3, wherein the first distance is one-quarter inch, the second distance is one-half inch, the third distance being three-quarters inch, the fourth distance being one inch.

5. The coalescing system of claim 1, wherein the first connection of the first coalescing plate is a pilot sleeve affixed to the first coalescing plate, the first connection of the second coalescing plate being a tiered support affixed to the second coalescing plate, the tiered support being a generally tubular member having a first shoulder formed thereon, the pilot sleeve bearing against the first shoulder of the tiered support so as to define the first distance between the first coalescing plate and the second coalescing plate.

6. The coalescing system of claim 2, wherein the first connection of the first coalescing plate is a first tiered support affixed to the first coalescing plate, the third connection of the second coalescing plate being a second tiered support affixed to the second coalescing plate, the second tiered support having an open end, the open end of the second tiered support receiving an end of the first tiered support received therein so as to define the second distance between the first coalescing plate and the second coalescing plate.

7. The coalescing system of claim 5, wherein the first connection is the pilot sleeve affixed to the first coalescing plate, the second connection of the second coalescing plate being the tiered support affixed to the second coalescing plate, the tiered support having a second shoulder formed thereon in spaced relation to the first shoulder of the tiered support, wherein the pilot sleeve extends over the tiered support so as to bear against the second shoulder of the tiered support so as to define third distance between the first coalescing plate and the second coalescing plate.

8. The coalescing system of claim 3, wherein the first connection of the first coalescing plate is an index support affixed to the first coalescing plate, the index support having an end directed toward the second coalescing plate, the fourth connection of the second coalescing plate being a tiered support, the tiered support having a receptacle at an end thereof, the end of the index support being received in the receptacle of the tiered support so as to define the fourth distance between the first coalescing plate and the second coalescing plate.

9. The coalescing system of claim 1, wherein the first connection of the first coalescing plate comprises a pair of first connections positioned in spaced relation to each other on the first coalescing plate, wherein the first and second connections of the second coalescing plate are a pair of first connections and a pair of second connections, the pair of first connections of the second coalescing plate being in spaced relation to each other, the pair of second connections of the second coalescing plate being in spaced relation to each other.

10. The coalescing system of claim 1, wherein the first connection of the second coalescing plate is a tiered support, the tiered support being a tubular member having a first shoulder and a second shoulder, the first shoulder being in spaced relation to the second shoulder longitudinally along the tiered support.

11. The coalescing system of claim 10, wherein the tiered support has a receptacle at one end thereof and an opening at an opposite end thereof.

12. The coalescing system of claim 11, wherein the first connection of the first coalescing plate is an index support having an end, the end of the index support being receivable in the receptacle of the tiered support.

13. The coalescing system of claim 11, wherein the first connection of the first coalescing plate is another tiered support having an end that is receivable in the opening of the tiered support of the second coalescing plate.

14. A coalescing stack assembly for use in a coalescing system, the coalescing stack assembly comprising:
a first coalescing plate;
a second coalescing plate extending in spaced relation to the first coalescing plate;
a first connection affixed to the first coalescing plate so as to face the second coalescing plate;
a first connection affixed to the second coalescing plate so as to face the first coalescing plate; and
a second connection affixed to the second coalescing plate so as to face the first coalescing plate, wherein the first connection of the first coalescing plate is joinable to one of the first and second connections of the second coalescing plate so as to define a first distance between the first coalescing plate and the second coalescing plate, said first coalescing plate being rotatable with respect to said second coalescing plate such that said first connection is joinable to another of said first and second connections of the second coalescing plate so as to define a second distance between the first coalescing plate and the second coalescing plate.

15. The coalescing stack assembly of claim 14, further comprising:
a third connection affixed to said second coalescing plate so as to face said first coalescing plate, said first coalescing plate being rotatable such that the first connection of said first coalescing plate is joinable to said third connection so as to define third distance between said first coalescing plate and said second coalescing plate.

16. The coalescing stack assembly claim 15, further comprising:
a fourth connection affixed to said second coalescing plate so as to face said first coalescing plate, said first coalescing plate being rotatable such that the first connection of said first coalescing plate is joinable to the fourth connection of said second coalescing plate so as to define a fourth distance between said first coalescing plate and said second coalescing plate.

17. The coalescing stack assembly of claim 16, wherein the first distance is one-quarter inch, the second distance being one-half inch, the third distance being three-quarters inch, the fourth distance being one inch.

18. The coalescing stack assembly of claim 14, wherein the first connection of said first coalescing plate comprises a pair of first connections in spaced relation to each other, said first connection of said second coalescing plate comprising a pair of first connections of said second coalescing plate, said third connection of said second coalescing plate comprising a pair of second connections of said second coalescing plate.

19. The coalescing stack assembly of claim 14, further comprising:
an indicia formed on at least one of said first coalescing plate and said second coalescing plate, said indicia being indicative of a direction of rotation of said first coalescing plate with respect to said second coalescing plate so as to move between the first distance and the second distance.
